(19) United States
(12) Patent Application Publication
(10) Pub. No.: US 2019/0220784 A1
(43) Pub. Date: Jul. 18, 2019

(54) Method for designing an adventure based on an adventure personality assessment

(71) Applicant: James Bunch, Boulder, CO (US)

(72) Inventor: James Bunch, Boulder, CO (US)

(21) Appl. No.: 15/869,754

(22) Filed: Jan. 12, 2018

(51) Int. Cl. G06Q 10/02; G06F 17/30

(52) U.S. Cl. CPC G06Q 10/025; G06F 17/30867; G06F 17/30528

(57) ABSTRACT

A method for designing an adventure based on identifying and assessing a person's personality traits (i.e. personality assessment). The personality assessment measures an adventure participant's personality characteristics which are relevant to adventure planning. The characteristics which are measured include desirability ratings for emotional risk taking, physical risk taking, freedom constraints, physical instability, learning, competing, uniqueness, social interaction and primitive conditions. Also, the invention includes a method for designing an adventure based on the adventure participants need for unity and rhythm.

### CROSS REFERENCE TO RELATED APPLICATIONS

Not Applicable.

### STATEMENT OF FEDERALLY SPONSORED RESEARCH OR DEVELOPMENT

Not Applicable.

### BACKGROUND OF THE INVENTION

Planning an adventure can be difficult. An adventure is different than a typical vacation because an adventure can involve physical risk and significant uncertainty. In addition, an adventure can involve physical exertion, physical obstacles (e.g. whitewater rapids), motion activities (e.g. zip lining), learning requirements and primitive conditions. The difficulty associated with planning an adventure can be compounded when more than one person is involved. Currently, there are numerous adventure travel websites which can be used for planning purposes. The adventure traveler can access the websites and choose an adventurous itinerary based on a specific destination.

The current method of selecting an itinerary from an adventure travel website can lead to numerous problems, especially, when there is a large group of people involved with the adventure. Once an adventure begins, an adventure participant may discover their needs, interests and motivations do not match the adventure itinerary and their needs differ significantly from their fellow adventure travelers. The discrepancy between the adventure participant expectations and the actual adventure can lead to dissatisfaction when the adventure is completed. The numerous problems associated with adventure planning are the result of the complex nature of adventures and the inadequacies of current adventure planning techniques to address the issues.

### BRIEF SUMMARY OF THE INVENTION

The invention provides a method which can be used to design an adventure based on the personality traits of each adventure participant. By focusing on individual personality traits, the invention provides a novel and comprehensive approach to designing an adventure. Adventure participants using the invention will dramatically improve their adventures because the adventure designs will account for the adventure participant's needs, interests and motivations.

The invention involves six steps. The six steps are illustrated in FIG. 1. The first step (110) creates an adventure personality assessment for each adventure participant. The assessment identifies personality traits which are relevant to adventure planning (e.g. risk taking). The second step (120) involves creating one or more preliminary designs based on the personality assessment(s). The third step reviews the design(s) (130) to see if the design(s) matches the needs, interests and motivations that were determined from the personality assessment(s). The fourth step is called unity. Unity checks to see if the design(s) indirectly improves the dominant needs that were identified in the personality assessment(s) (140). The fifth step is called rhythm. Rhythm checks the design(s) itinerary and activities to determine if there is adequate rhythm (150). Adequate rhythm is determined by each adventure participant. The sixth step involves choosing the best design (160). The best design will be used for the adventure.

### BRIEF DESCRIPTION OF THE SEVERAL VIEWS OF THE DRAWING

FIG. 1 illustrates an overview of the invention. The invention is comprised of six steps which are described by boxes and triangles in FIG. 1.

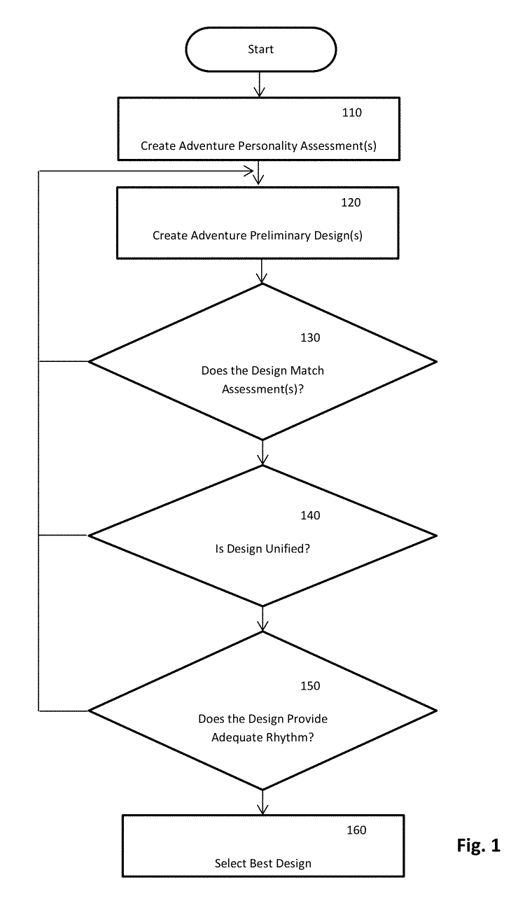

FIG. 2 illustrates three design principles which are used to create visual bars. Visual bars are used to define personality traits. The three design principles are dominance, opposition and balance.

FIG. 3 illustrates a visual bar for physical safety and physical risk. FIG. 3 can be used to define the personality trait for physical risk taking desirability.

FIG. 4 illustrates a visual bar for emotional safety and emotional risk. FIG. 4 can be used to define the personality trait for emotional risk taking desirability.

FIG. 5 illustrates a visual bar for physical stability and physical instability. FIG. 5 can be used to define the personality trait for physical instability desirability.

FIG. 6 illustrates a visual bar for knowledge/skills and learning. FIG. 6 can be used to define the personality trait for learning desirability.

FIG. 7 illustrates visual bars for comparing a preliminary design with a personality assessment. FIG. 7 can be used to determine if a preliminary design matches a personality assessment.

### DETAILED DESCRIPTION OF THE INVENTION

The invention involves six steps (see ‘Brief Summary of the Invention’ for an overview of the six steps). The first step (110) is the most important step. This step creates the adventure personality assessment. The adventure personality assessment is based on three design principles. The purpose of each design principle is to maximize harmony for the adventure participant. Harmony is defined as a pleasing sensation which is the result of combining adventure variables. There are twenty adventure variables which are used in the adventure personality assessment. The reason harmony is important in step one is because harmony is the main purpose for pursuing an adventure. In other words, an adventure is pursued by a person because an adventure provides pleasure. Consequently, the purpose of the adventure personality assessment is to define personality traits which are relevant to maximizing harmony during an adventure.

The first design principle which is used in the adventure personality assessment is called dominance. Dominance is when a person experiences harmony because an instinctual need has been satisfied. Examples of instinctual needs are physical safety and the need for freedom. When someone pursues an adventure, the person should satisfy their instinctual needs to experience harmony. Fulfilling an instinctual need is considered a dominant need. The following list describes ten dominant needs which are used in the adventure personality assessment:
1. Emotional safety is a dominant need. Emotional safety refers to a person's need to successfully complete an important task.
2. Physical safety is a dominant need. Physical safety refers to a person's need to remain physically safe.
3. Freedom is a dominant need. Freedom refers to a person's need for freedom of physical movement.
4. Physical stability is a dominant need. Physical stability refers to a person's need to remain physically stable.
5. Physical activity is a dominant need. Physical activity refers to a person's need to physically move about.
6. Knowledge and skills prerequisites is a dominant need. Knowledge and skills prerequisites refers to a person's need for having sufficient knowledge and skills for a given task, event or situation.
7. Competing with your self is a dominant need. Competing with your self refers to the standard level of performance a person requires when performing a task or activity.
8. Familiarity with your surroundings is a dominant need. Familiarity refers to a person's need to be familiar with their surroundings.
9. Privacy is a dominant need. Privacy refers to a person's need for privacy for themselves and their group.
10. Resources is a dominant need. Resources refers to a person's need for the types of resources they are accustomed to.

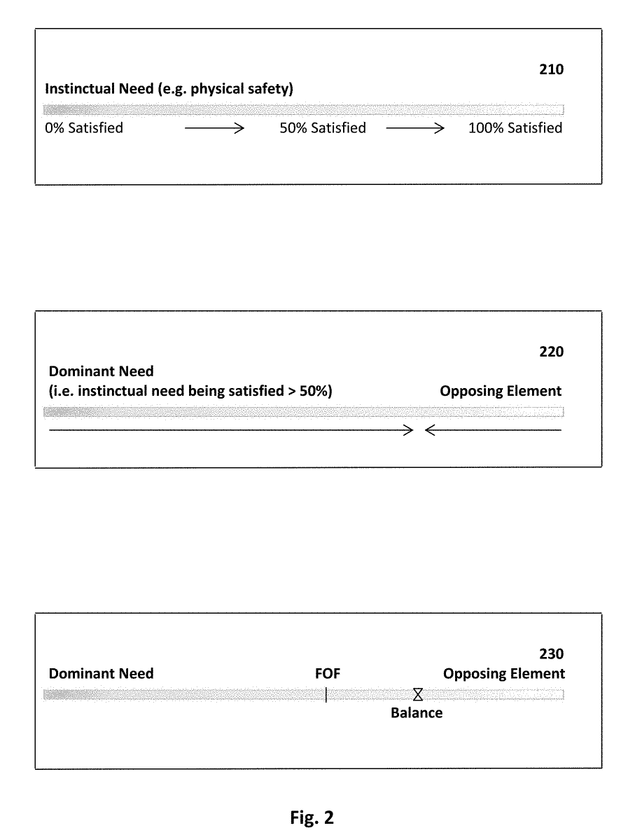

The visual bar (210) in FIG. 2 represents the satisfaction level for an instinctual need. Moving from left to right, the scale measures being 0-100% satisfied. An instinctual need is considered dominant when the satisfaction level exceeds the 50% mark on the visual bar. For example, someone hiking along a rocky trail may feel safe but not 100% safe. For instance, the hiker could trip on a rock and injure themselves. In this situation, the hiker may consider themselves 97% safe (i.e. mostly safe) and therefore the instinctual need for physical safety would be dominant. Note: The percentage that is assigned to the visual bar is based on the perception of the activity or event and may not correspond to statistical analysis (e.g. hiking injuries/1000 hikers).

Opposition is the second design principle which is used in the adventure personality assessment. Opposition is when a person adds an adventure variable which opposes a dominant need. The invention refers to an opposing adventure variable as an opposing element. When a person adds an opposing element to a dominant need, they can increase harmony beyond what is achievable from dominance alone. For example, a person can improve harmony by adding physical risk to physical safety. However, a person can only add a certain amount of physical risk to improve harmony. If a person adds too much physical risk then they can create disharmony. The correct amount to add is entirely dependent on each adventure participant personality trait.

The following list describes ten opposing elements which are used in the adventure personality assessment:
1. Emotional risk is an opposing element. Emotional risk opposes emotional safety.
2. Physical risk is an opposing element. Physical risk opposes physical safety.
3. Freedom constraint is an opposing element. Freedom constraint opposes freedom.
4. Physical instability is an opposing element. Physical instability opposes physical stability.
5. Physical exertion is an opposing element. Physical exertion opposes physical activity.
6. Learning is an opposing element. Learning opposes a person's current knowledge and skills prerequisites.
7. Competition is an opposing element. Competition opposes competing with yourself.
8. Uniqueness is an opposing element. Uniqueness opposes familiarity.
9. Social interaction is an opposing element. Social interaction opposes privacy.
10. Lack of resources is an opposing element. Lack of resources opposes resources.

The visual bar (220) in FIG. 2 has been modified to include an opposing element. An opposing element adversely affects an instinctual need. If you use physical safety as an example, an opposing element (i.e. physical risk) can result in risk to a person's instinctual need for physical safety.

Balance is the third design principle which is used in the adventure personality assessment. Balance is when a person maximizes harmony by adding the correct amount of opposing element to a dominant need. The correct balance is dependent on each adventure participant's personality trait. If a person adds too much opposing element, they can invoke a Fight-or-Flight response (FOF). An FOF is when an opposing element approaches dominance and the dominant need starts to lose its dominance. For example, if a person increases physical risk to the point it becomes dominant, the adventure participant will fight to regain dominance for physical safety or they will flee the situation thereby eliminating physical risk. The personality assessment discourages FOF situations because FOF situations are potentially dangerous and can decrease harmony. The following visual bar (230) has been modified to include a balance symbol (i.e. carrot symbol) and a FOF indicator.

There are ten visual bars in the adventure personality assessment. Each visual bar is used to document a specific personality trait. The ten personality traits that are documented by the adventure personality assessment are: emotional risk taking desirability, physical risk taking desirability, freedom constraint desirability, physical instability desirability, physical exertion desirability, learning desirability, competing with others desirability, uniqueness desirability, social interaction desirability and limited resources desirability. The visual bars can be represented by a computer program (e.g. slider bar display tool) or the visual bars can be represented in a paper document.

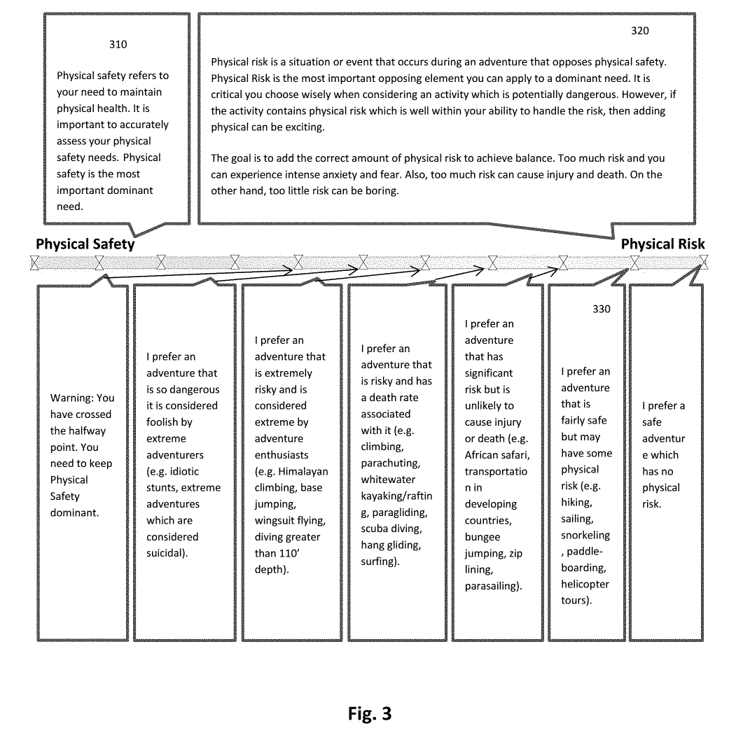

The visual bar in FIG. 3 illustrates the personality traits for physical safety (i.e. dominant need) and physical risk (i.e. opposing element). Physical safety is a dominant need because everyone has an instinctual need for remaining physically safe. Physical risk can be added to physical safety to create a sense of excitement (i.e. harmony). The amount of risk that is added to create excitement depends on the person. Some people enjoy risk and some people hate risk. One of the purposes of the invention is to determine which opposing elements are preferred by adventure participants and how much they prefer. The process of selecting an opposing element and how much opposing element an adventure participant prefers is how the invention determines a personality trait.

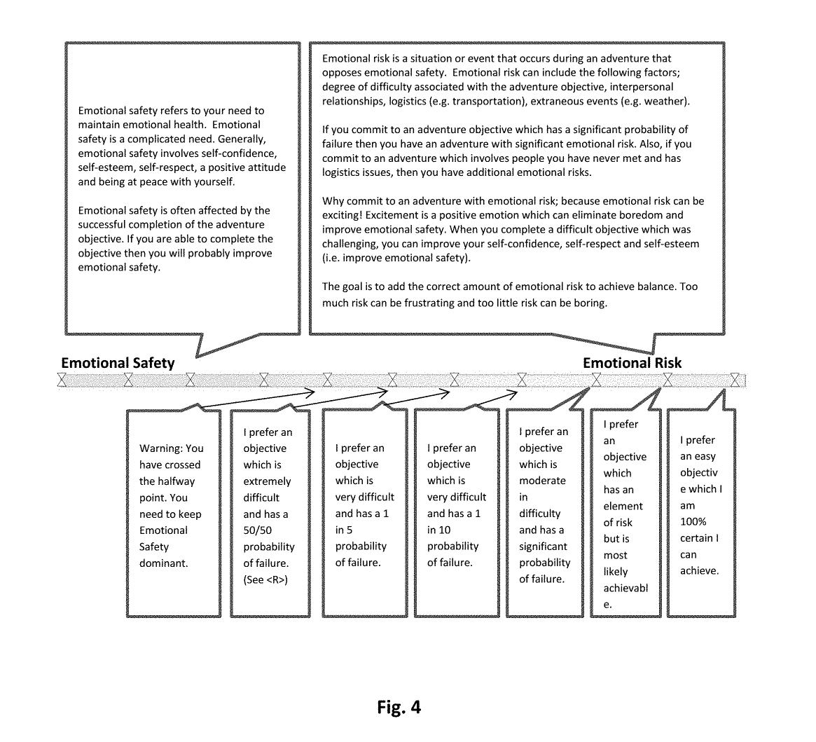

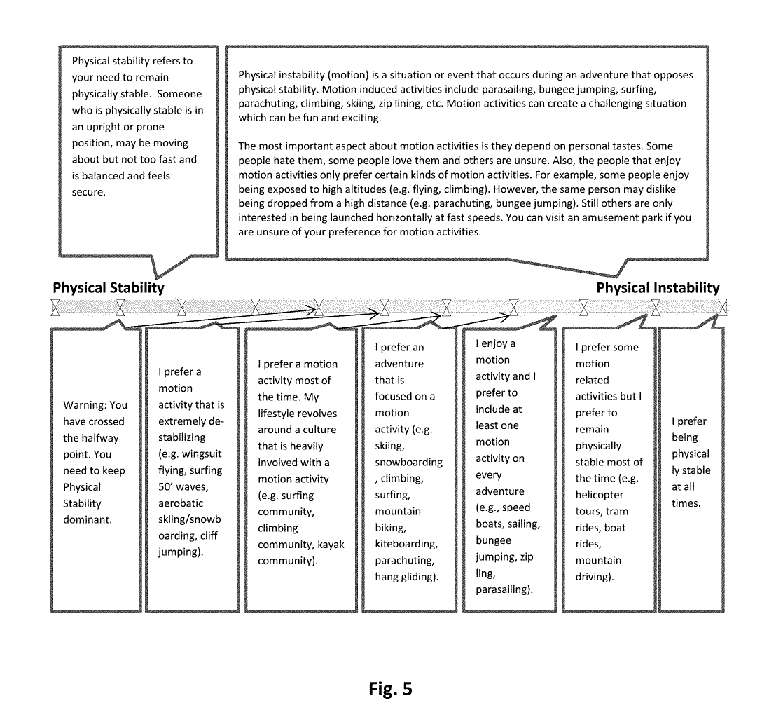

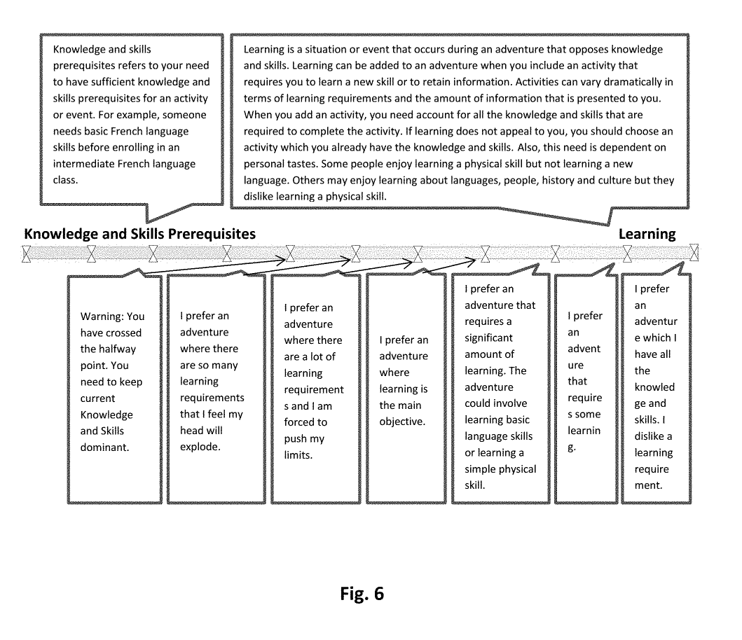

The box (310) in FIG. 3 provides a definition for physical safety. The box (320) provides a definition for physical risk. Each box below the visual bar represents a definition for balance. The adventure participant can select one box below the visual bar. The box they select is a personality trait. The adventure participant has the option of overwriting the text in the box they select. For example, if the adventure participant selects box (330) they have the option of overwriting the text “(e.g. hiking, sailing, snorkeling, paddle boarding, helicopter tours)” and entering whatever information they prefer. FIGS. 4, 5 and 6 provide three other examples of visual bars that are used in the adventure personality assessment.

Step 2 (120) can be initiated after each adventure participant completes an adventure personality assessment. Step 2 involves creating one or more preliminary designs based on the personality assessment(s). The preliminary design(s) that are created need to take into account the information (e.g. preferred activities and destinations) that was filled out in the adventure personality assessment(s). For example, if all the assessments include a strong desirability for learning about African wildlife then the preliminary design should include an activity that involves learning about African wildlife.

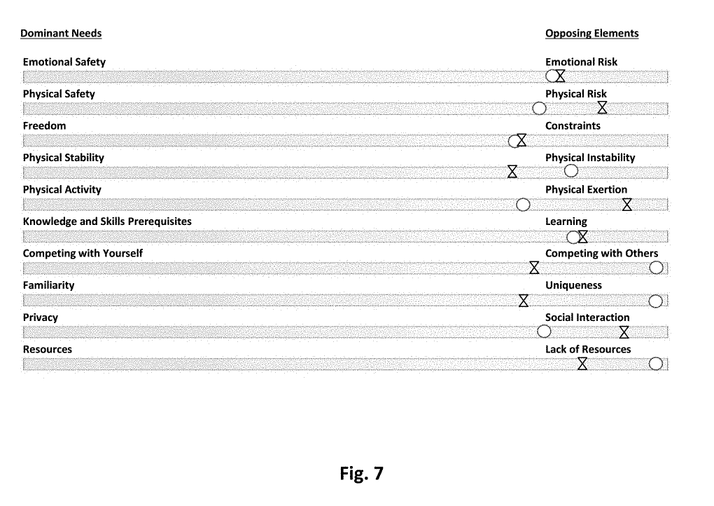

Step 3 (130) can be initiated after all the preliminary designs have been completed. Step 3 involves reviewing each preliminary design to see if the design matches the adventure personality assessment(s). If a preliminary design does not match the adventure personality assessment(s) then the preliminary design may need to be modified or eliminated. FIG. 7 demonstrates the matching process when comparing a preliminary design with a personality assessment. The circle represents the preliminary design value and the triangles are the personality assessment value. Generally, if the circle is significantly to the left of the triangles then this could indicate anxiety and frustration for the preliminary design. If the circle is significantly to the right then this could indicate boredom for the preliminary design.

Step 4 (140) can be initiated after all the preliminary design(s) have been reviewed. Step 4 determines if a preliminary design involves unity. Unity is when an activity in a preliminary design includes an opposing element that improves a dissimilar dominant need. The two activities listed below are examples of unity:
Learning a foreign language in a developing country involves unity. When you learn (opposing element) a foreign language in a developing country, you improve your dissimilar dominant need for freedom and your dissimilar dominant need for emotional and physical safety. In other words, learning a foreign language in a developing country allows you to travel more easily and it improves your ability to remain emotionally and physically safe.
Trekking to Machu Picchu involves unity because the trek requires physical exertion (opposing element) in order to improve freedom and emotional security (dissimilar dominant needs). When you complete a Machu Picchu trek, you experience harmony because you maintained your dominant need for physical activity (e.g. most of the hike is at a leisurely pace), you applied opposition to your dominant need for physical activity (e.g. physical exertion is required to cross a 14,000 foot pass), and you applied unity because physical exertion allows you to move freely in one direction and physical exertion allows you to complete the adventure objective which is arriving in Machu Picchu.

Unity can be measured for an activity in a preliminary design by listing all the opposing elements for the activity and then listing all the dissimilar dominant needs that are improved for each of the opposing elements. Each preliminary design is reviewed for unity. If a preliminary design does not involve unity then the preliminary design may need to be modified or eliminated.

Step 5 (150) can be initiated after all the preliminary design(s) have been reviewed for unity. Step 5 determines if a preliminary design has adequate rhythm. Adequate rhythm is determined by the repetitive physical movements of an activity and by the overall pace of the itinerary in a preliminary design. The invention determines if a preliminary design has adequate rhythm by asking each adventure participant to fill out a questionnaire. The questionnaire provides information, instructions and a list of questions on how to improve rhythm when creating a preliminary design. If a preliminary design does not have adequate rhythm according to the adventure participant(s), then the preliminary design may need to be modified or eliminated.

Step 6 (160) can be initiated after all the preliminary design(s) have been reviewed for rhythm. Step 6 involves reviewing the preliminary design(s) and selecting the best design. The review process includes comparing the preliminary design(s) to the adventure personality assessment(s) and reviewing the designs for unity and adequate rhythm. The best preliminary design will be used for the adventure.

What is claimed:

1. A method for creating adventure preliminary design(s) based on adventure personality assessment(s), wherein said method comprises the steps of:
a. Determining emotional risk taking desirability for adventure participant(s);
b. Determining physical risk taking desirability for adventure participant(s);
c. Determining freedom constraint desirability for adventure participant(s);
d. Determining physical instability desirability for adventure participant(s);
e. Determining physical exertion desirability for adventure participant(s);
f. Determining learning desirability for adventure participant(s);
g. Determining competing with others desirability for adventure participant(s);
h. Determining uniqueness desirability for adventure participant(s);
i. Determining social interaction desirability for adventure participant(s);
j. Determining lack of resources desirability for adventure participant(s);
k. Creating preliminary design(s) based on desirability ratings for adventure participant(s);
l. Modifying preliminary design(s) as needed when preliminary design(s) do not match the personality assessment(s);

2. The method of claim 1 wherein the step of determining emotional risk taking desirability for adventure participant(s) comprises the steps of:
a. Provide a definition for emotional safety;
b. Provide a definition for emotional risk;
c. Determine the balance (i.e. emotional risk taking desirability) between emotional safety and emotional risk;

3. The method of claim 1 wherein the step of determining physical risk taking desirability for adventure participant(s) comprises the steps of:
a. Provide a definition for physical safety;
b. Provide a definition for physical risk;
c. Determine the balance (i.e. physical risk taking desirability) between physical safety and physical risk;

4. The method of claim 1 wherein the step of determining freedom constraint desirability for adventure participant(s) comprises the steps of:
a. Provide a definition for freedom;
b. Provide a definition for freedom constraint;
c. Determine the balance (i.e. freedom constraint desirability) between freedom and freedom constraint;

5. The method of claim 1 wherein the step of determining physical instability desirability for adventure participant(s) comprises the steps of:
a. Provide a definition for physical stability;
b. Provide a definition for physical instability;
c. Determine the balance (i.e. physical instability desirability) between physical stability and physical instability;

6. The method of claim 1 wherein the step of determining physical exertion desirability for adventure participant(s) comprises the steps of:
a. Provide a definition for physical activity;
b. Provide a definition for physical exertion;
c. Determine the balance (i.e. physical exertion desirability) between physical activity and physical exertion;

7. The method of claim 1 wherein the step of determining learning desirability for adventure participant(s) comprises the steps of:
a. Provide a definition for knowledge/skills;
b. Provide a definition for learning;
c. Determine the balance (i.e. learning desirability) between knowledge/skills and learning;

8. The method of claim 1 wherein the step of determining competing with others desirability for adventure participant(s) comprises the steps of:
a. Provide a definition for competing with yourself;
b. Provide a definition for competing with others;
c. Determine the balance (i.e. competing with others desirability) between competing with yourself and competing with others;

9. The method of claim 1 wherein the step of determining uniqueness desirability for adventure participant(s) comprises the steps of:
a. Provide a definition for familiarity;
b. Provide a definition for uniqueness;
c. Determine the balance (i.e. uniqueness desirability) between familiarity and uniqueness;

10. The method of claim 1 wherein the step of determining social interaction desirability for adventure participant(s) comprises the steps of:
a. Provide a definition for privacy;
b. Provide a definition for social interaction;
c. Determine the balance (i.e. social interaction desirability) between privacy and social interaction;

11. The method of claim 1 wherein the step of determining lack of resources desirability for adventure participant(s) comprises the steps of:
a. Provide a definition for resources;
b. Provide a definition for lack of resources;
c. Determine the balance (i.e. lack of resources desirability) between resources and lack of resources;

12. The method of claim 1 wherein the step of creating preliminary design(s) based on desirability ratings for adventure participant(s) comprises the steps of:
a. Determine activities from desirability information;
b. Determine destinations from desirability information;
c. Create preliminary designs based on activities and destinations;

13. The method of claim 1 wherein the step of modifying preliminary design(s) as needed when preliminary design(s) do not match the personality assessment(s) comprises the steps of:
a. Compare the preliminary design(s) to the adventure personality assessment(s);
b. Modify the preliminary design(s) when significant discrepancies are observed between the preliminary designs(s) and the personality assessment(s);

14. A method for modifying a preliminary design based on how unified the design is, wherein said method comprises the steps of:
a. Determine the opposing elements for design activities;
b. Determine the dissimilar dominant needs that are improved by the opposing elements;
c. Modify the preliminary design(s) if there is insufficient unity;

15. A method for modifying a preliminary design based on adequate rhythm, wherein said method comprises the steps of:
a. Determine whether the design includes activities with repetitive physical movements;
b. Determine whether the design itinerary has good overall pace;
c. Modify the preliminary design(s) if there is insufficient rhythm;

16. A method for selecting the best preliminary design, wherein said method comprises the steps of:
a. Compare the preliminary designs to the adventure personality assessment(s);
b. Review the preliminary designs for unity;
c. Review the preliminary designs for rhythm;
d. Select the best preliminary design based on the comparisons and reviews;
